(19) United States
(12) Patent Application Publication
(10) Pub. No.: US 2026/0319561 A1
(43) Pub. Date: Oct. 15, 2026

(54) TECHNIQUES FOR SMART SLEEP

(71) Applicant: Sonos, Inc., Goleta, CA (US)

(72) Inventor: Matthew Benatan, Stockport (GB)

(21) Appl. No.: 19/485,053

(22) PCT Filed: May 17, 2024
(86) PCT No.: PCT/US2024/029967

§ 371 Date: Nov. 17, 2025

Related U.S. Application Data
(60) Provisional application No. 63/502,955, filed on May 18, 2023.
(60) Provisional application No. 63/586,692, filed on Sep. 29, 2023.

(51) Int. Cl. G06F 1/3206; G05B 13/02; G06F 1/3234; G06F 3/16

(52) U.S. Cl. CPC G06F 1/3206; G05B 13/0265; G06F 1/3234; G06F 3/165

(57) ABSTRACT

In one example, a method of power management for a playback device includes acquiring a training data set containing correlations between playback device activity and time of day, training a parameterized machine learning model to predict an activity schedule for the playback device using the training data set, collecting, over time, an operating data set including sample values of activity status of the playback device and, for each respective sample value, a time at which the respective sample value was collected, applying the model to the operating data set to generate a predicted activity schedule for the playback device and a confidence metric corresponding to the predicted activity schedule, and based thereon, generating a power management schedule for the playback device. The power management schedule may identify a plurality of consecutive time intervals and, for each time interval, an associated activity status (e.g., active or sleep) of the playback device.

### CROSS REFERENCE TO RELATED APPLICATIONS

This application claims priority to co-pending U.S. Provisional Application No. 63/502,955 filed on May 18, 2023 and titled “SMART SLEEP,” and to co-pending U.S. Provisional Application No. 63/586,692 filed on Sep. 29, 2023 and titled “TECHNIQUES FOR SMART SLEEP,” each of which is hereby incorporated herein by reference in its entirety for all purposes.

### FIELD OF THE DISCLOSURE

The present disclosure is related to consumer goods and, more particularly, to methods, systems, products, aspects, services, and other elements directed to media playback or some aspect thereof.

### BACKGROUND

Options for accessing and listening to digital audio in an out-loud setting were limited until in 2002, when Sonos, Inc. began development of a new type of playback system. Sonos then filed one of its first patent applications in 2003, entitled “Method for Synchronizing Audio Playback between Multiple Networked Devices,” and began offering its first media playback systems for sale in 2005. The SONOS Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Various aspects, and advantages of the presently disclosed technology may be better understood with regard to the following description, appended claims, and accompanying drawings, as listed below. A person skilled in the relevant art will understand that the attributes shown in the drawings are for purposes of illustrations, and variations, including different and/or additional attributes and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIGS. 1I through 1L are schematic diagrams of corresponding media playback system zones.

FIG. 1M is a schematic diagram of media playback system areas.

FIG. 2 is a side isometric view of an example of a playback device configured in accordance with aspects of the disclosed technology.

FIG. 3 is a conceptual diagram illustrating aspects of a positioning system architecture in accordance with aspects of the disclosure.

FIG. 4 is a diagram illustrating software components of an example playback device in accordance with aspects of the disclosed technology.

FIG. 5 is a block diagram of circuitry that may be included in a sleep-capable playback device in accordance with aspects of the disclosed technology.

FIG. 6 is a block diagram of one example of a machine learning system in accordance with aspects of the present disclosure.

FIG. 7 is a flow diagram of one example of a process implemented using the machine learning system of FIG. 6, in accordance with aspects of the present disclosure.

FIG. 8 is a histogram showing an example of training data that can be used in the process of FIG. 7, in according with aspects of the present disclosure.

FIG. 9 is a graph showing an example of an output from the model predictive controller of the machine learning system of FIG. 6, in accordance with aspects of the present disclosure.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Embodiments described herein relate to power-saving mechanisms and methodologies that can be applied to and implemented by one or more playback devices in a media playback system. Environmental concerns, as well as many new and evolving regulations, can drive a need for various electronic devices, including playback devices, to consume less energy. In many media playback systems, one or more playback devices may typically spend considerable time in an inactive or idle state, in which the playback device is not actively playing music or other audio content. Such circumstances provide an ideal opportunity for power savings that do not impact the user's listening experience. Accordingly, in some examples, one or more idle playback devices in a media playback system can be configured to enter a suspended (also referred to as a “sleep”) state/mode, in which certain electronic components are powered down to reduce energy consumption. Configuring idle playback devices to use sleep mode can significantly reduce idle power consumption and offer additional benefits, such as extending battery life and longevity of portable playback devices, for example. In addition, automatic sleep scheduling conserves power without requiring users to manually set playback devices into a sleep mode when the playback devices are not in use.

However, in implementing automated power-saving aspects, it is desirable to avoid loss of ability to respond to user input and commands (e.g., to begin playback of music or other audio content) and to minimize requirements for users to manually “turn off” power-saving aspects or otherwise reactivate playback devices that may be in a power-saving mode. In particular, many users may be intolerant of disruptions to their listening experience caused by encountering a sleeping playback device (e.g., a user utters a voice command to begin a playback session, but the playback device does not respond because it is in the sleep mode). Thus, avoiding negative user experiences caused by automated power management may be highly desirable.

Accordingly, aspects and embodiments disclosed herein provide techniques by which power consumption of playback devices can be reduced with minimal disruption to users' listening experiences. In certain examples, user-centric machine learning approaches are applied to learn playback device usage patterns over time such that automatic sleep scheduling can be implemented in a manner that achieves significant power savings while also minimizing (or at least reducing) the likelihood that a user will encounter a sleeping, and therefore non-responsive, playback device. Routines are an important aspect of how users interact with technology, and in particular, of how users engage with music and other audio through their media playback systems. Within this context, learned/recognized routines can be used to develop sleep schedules that align with patterns of idle time for playback devices and therefore can be automated without negatively impacting the user experience. For example, if routine information demonstrates that one or more playback devices in a media playback system are never (or almost never) used between 2 a.m. and 4 a.m. on weekdays, those playback devices can be safely scheduled to sleep during that time window, with minimal risk that a user will want to interact with the playback devices while they are in the sleep mode. While generalized trends and shifts in routine can provide useful information, techniques disclosed herein provide additional value through the ability to gather personalization data and adapt sleep scheduling to the behavior of individual households or users. Further, confidence metrics can be used to limit the automatic power management to scenarios in which the likelihood of a negative user experience is very low, as described below. In addition, examples provide users with options for whether or not to engage power saving aspects, and when to do so, thus providing a flexible and customizable approach to power-saving that can be controlled by the users.

In some embodiments, for example, a method of power management for a playback device includes acquiring a training data set containing correlations between playback device activity and time of day, and training a parameterized machine learning model to predict an activity schedule for the playback device using the training data set. Examples of the method further include collecting, over time, an operating data set including sample values of an activity status of the playback device and, for each respective sample value, a time at which the respective sample value was collected, and applying the parameterized machine learning model to the operating data set to generate a predicted activity schedule for the playback device and a confidence metric corresponding to the predicted activity schedule. Based on the predicted activity schedule and the confidence metric, a power management schedule can be generated for the playback device. The power management schedule may identify a plurality of consecutive time intervals and, for each time interval, an associated activity status of the playback device. The activity status may correspond to an active status or to a sleep status in which the playback device suspends an operating system and one or more programs, the one or more programs including a control program configured to instruct the playback device to play back audio content.

While some examples described herein may refer to functions performed by given actors such as “users,” “listeners,” and/or other entities, it should be understood that such references are for purposes of explanation only. The claims should not be interpreted to require action by any such example actor unless explicitly required by the language of the claims themselves.

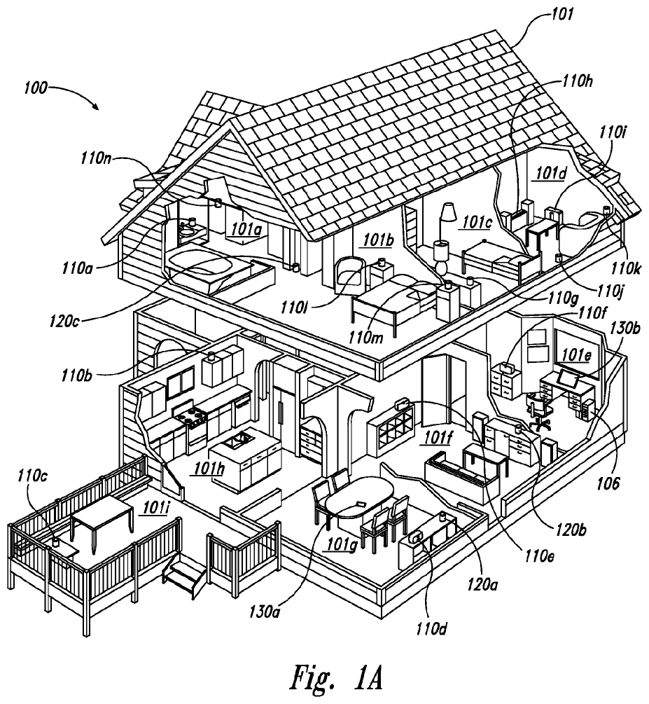

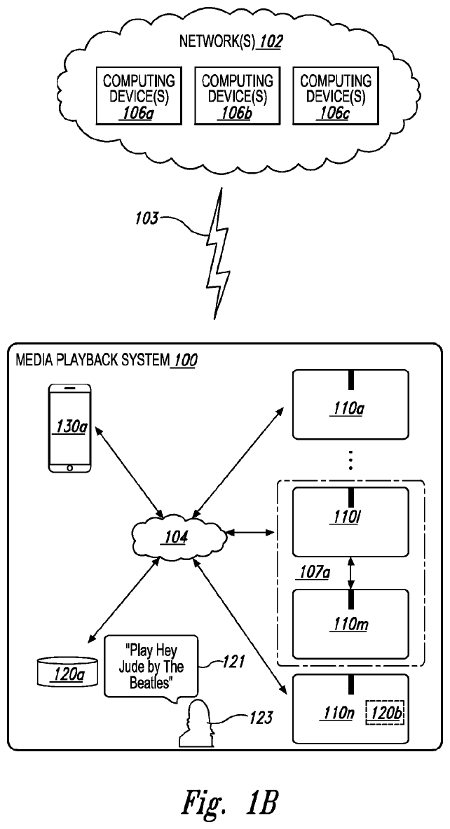

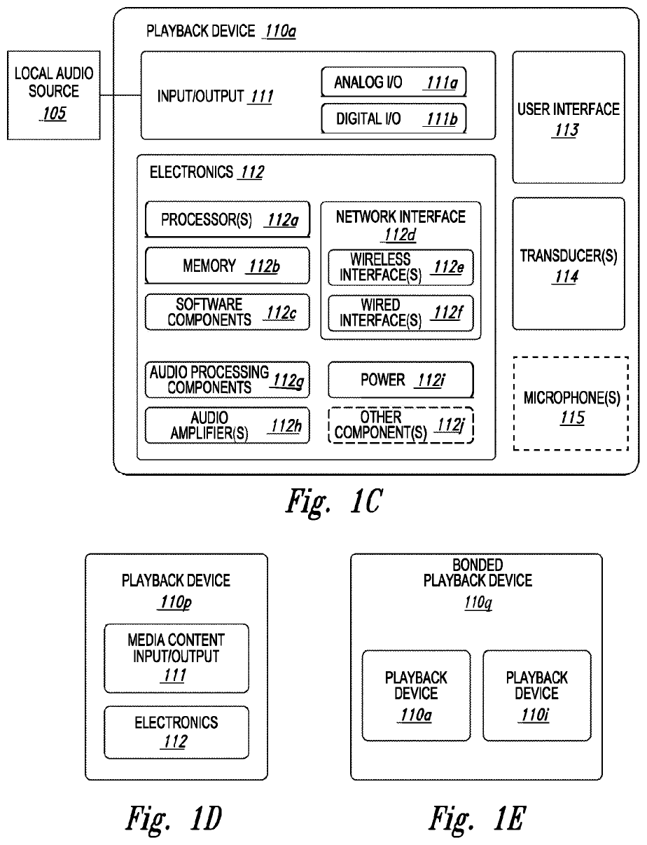

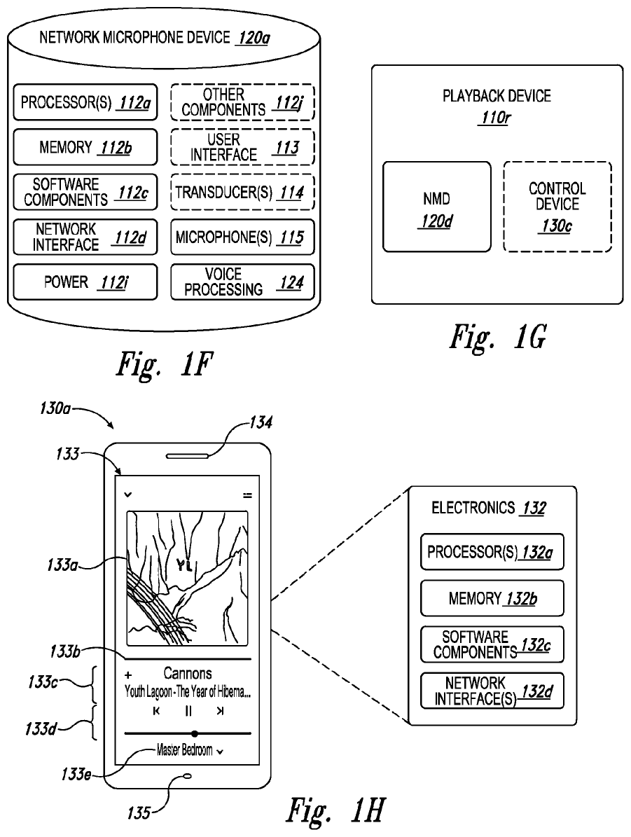

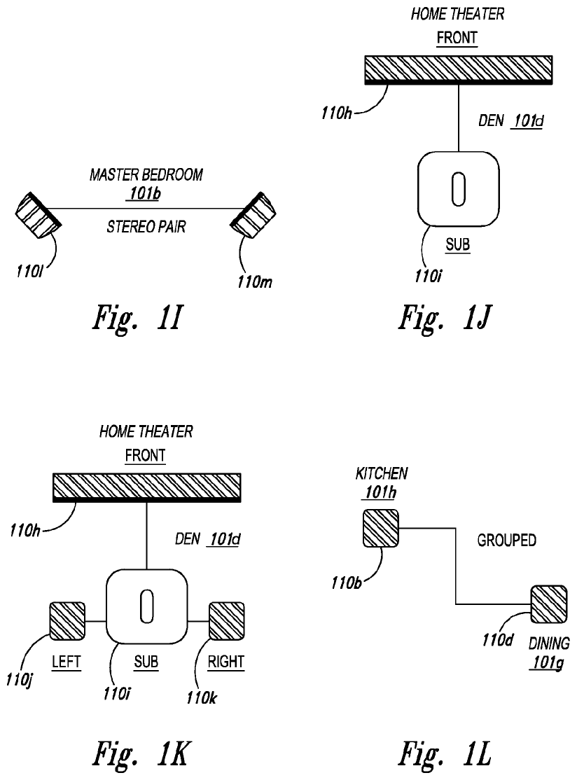

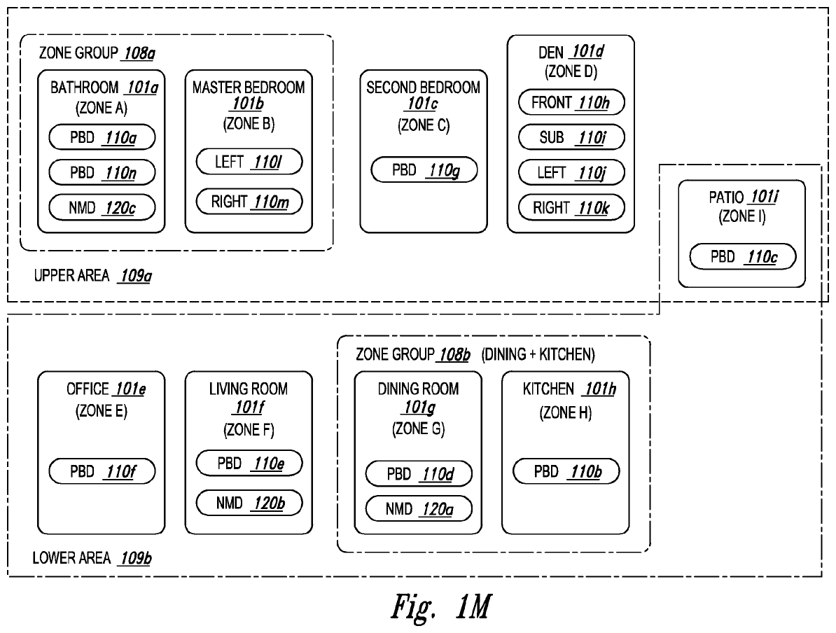

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other characteristics shown in the Figures are merely illustrative of particular embodiments of the disclosed technology. Accordingly, other embodiments can have other details, dimensions, angles, and characteristics without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices, etc.) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation, etc.). In some embodiments, for example, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various embodiments of the disclosure are described in greater detail below with respect to FIGS. 1B-5.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the second bedroom 101c, the office 101e, the living room 101f, the dining room 101g, the kitchen 101h, and the outdoor patio 101i each include one playback device 110, and the master bathroom 101a, the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-k can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B, 1E and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks), etc. The cloud network 102 is configured to deliver media content (e.g., audio content, video content, photographs, social media content, etc.) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WI-FI network, a BLUETOOTH, a Z-WAVE network, a ZIGBEE, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WI-FI” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household or commercial facility communication network (e.g., a household or commercial facility WI-FI network). In some embodiments, the links 103 and the network 104 comprise one or more of the same networks. In some aspects, for example, the links 103 and the network 104 comprise a telecommunication network (e.g., an LTE network, a 5G network, etc.). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud servers that host cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length, etc.) and other associated information (e.g., URIs, URLs, etc.) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1I through 1M.

The media playback system 100 includes the NMDs 120a and 120b, each comprising one or more microphones configured to receive voice utterances from a user. In the illustrated embodiment of FIG. 1B, the NMD 120a is a standalone device and the NMD 120b is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS, AMAZON, GOOGLE, APPLE, MICROSOFT, etc.). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WI-FI, BLUETOOTH, or another suitable communication link. In certain embodiments, the analog I/O 111a and the digital I/O 111b comprise interfaces (e.g., ports, plugs, jacks, etc.) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a BLUETOOTH connection, an ad hoc wired or wireless communication network, and/or another suitable communication link). The local audio source 105 can comprise, for example, a mobile device (e.g., a smartphone, a tablet, a laptop computer, etc.) or another suitable audio component (e.g., a television, a desktop computer, an amplifier, a phonograph (such as an LP turntable), a Blu-ray player, a memory storing digital media files, etc.). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens, etc.), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

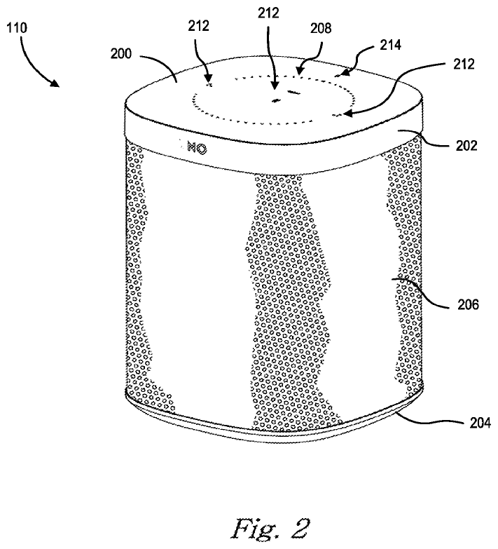

As an illustrative example, FIG. 2 shows an example housing 200 of a playback device 110 that includes a user interface 113 in the form of a control area 210 at a top portion 202 of the housing 200. The housing may comprise the top portion 202, a lower portion 204, and an intermediate portion 206. In some examples, the control area 210 includes buttons 212 for controlling audio playback, volume level, and other functions. The control area 210 may also include a button 214 for toggling the microphones 115 to either an on state or an off state. In certain examples, the control area 210 is at least partially surrounded by apertures 208 formed in the top portion 202 of the housing 200 through which the microphones 115 (not visible in FIG. 2) receive the sound in the environment of the playback device 110. The microphones 115 may be arranged in various positions along and/or within the top portion 202 or other areas of the housing 200 so as to detect sound from one or more directions relative to the playback device 110.

Referring again to FIG. 1C, in the illustrated example, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases, etc.).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone, etc.).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which is incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds, etc.) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receive and process the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WI-FI, BLUETOOTH, LTE, etc.). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 exclude the network interface 112d altogether and transmit and receive media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DACs), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omit the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers 112h include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 include a single one of the amplifiers 112h configured to output amplified audio signals to a plurality of the transducers 114. In some other embodiments, the electronics 112 omit the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, Sonos, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT: AMP,” “CONNECT,” “AMP,” “PORT,” and “SUB.” Other suitable playback devices may additionally or alternatively be used to implement the playback devices of example embodiments disclosed herein. Additionally, one of ordinary skill in the art will appreciate that a playback device is not limited to the examples described herein or to Sonos product offerings. In some embodiments, for example, one or more playback devices 110 comprise wired or wireless headphones (e.g., over-the-ear headphones, on-ear headphones, in-ear earphones, etc.). In other embodiments, one or more of the playback devices 110 comprise a docking station and/or an interface configured to interact with a docking station for personal mobile media playback devices. In certain embodiments, a playback device may be integral to another device or component such as a television, an LP turntable, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is a full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 112h, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers, etc.).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1C) configured to receive user input (e.g., touch input, voice input, etc.) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON VAS, a user might speak the activation word “Alexa.” Other examples include “Ok, Google” for invoking the GOOGLE VAS and “Hey, Siri” for invoking the APPLE VAS.

After detecting the activation word, voice processing components 124 monitor the microphone data for an accompanying user request in the voice input. The user request may include, for example, a command to control a third-party device, such as a thermostat (e.g., NEST thermostat), an illumination device (e.g., a PHILIPS HUE lighting device), or a media playback device (e.g., a SONOS playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other attributes, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone, etc.) on which media playback system controller application software is installed. In some embodiments, the control device 130a comprises, for example, a tablet (e.g., an iPad™), a computer (e.g., a laptop computer, a desktop computer, etc.), and/or another suitable device (e.g., a television, an automobile audio head unit, an IoT device, etc.). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 132b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE, etc.). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection, etc.) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1I through 1M.

The user interface 133 is configured to receive user input and can facilitate control of the media playback system 100. The user interface 133 includes media content art 133a (e.g., album art, lyrics, videos, etc.), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year, etc.) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone, etc.). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound, etc.) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones.

e. Suitable Playback Device Configurations

FIGS. 1I through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 1101 (e.g., a left playback device) can be bonded to the playback device 110m (e.g., a right playback device) to form Zone B. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110b and 110d can be merged to form a merged group or a zone group 108b. The merged playback devices 110b and 110d may not be specifically assigned different playback responsibilities. That is, the merged playback devices 110b and 110d may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1I, the playback devices 1101 and 110m may be bonded so as to produce or enhance a stereo effect of audio content. In this example, the playback device 1101 may be configured to play a left channel audio component, while the playback device 110m may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1K shows the Front and SUB devices 110h and 110i further bonded with Left and Right playback devices 110j and 110k, respectively. In some implementations, the Left and Right devices 110j and 110k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in U.S. Pat. No. 10,499,146 filed on Feb. 21, 2017 and titled “VOICE CONTROL OF A MEDIA PLAYBACK SYSTEM,” which is incorporated herein by reference in its entirety for all purposes.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variable instances may be stored with identifiers (e.g., tags) corresponding to type. For example, certain identifiers may be a first type “al” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the memory may store variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D and I, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. Pat. No. 10,712,997 filed Aug. 21, 2017, and titled “Room Association Based on Name,” and U.S. Pat. No. 8,483,853 filed Sep. 11, 2007, and titled “Controlling and manipulating groupings in a multi-zone media system.” Each of these patents is incorporated herein by reference in its entirety. In some embodiments, the media playback system 100 may not implement Areas, in which case the system may not store variables associated with Areas.

### III. Positioning System Examples

As discussed above, a plurality of playback devices 110 and/or NMDs 120 can be distributed within an environment 101, such as a user's home, or a commercial space such as a restaurant, retail store, mall, hotel, etc. Some of the devices may be in relatively fixed locations within the environment 101, whereas others may be portable and be frequently moved from one location to another. According to certain aspects, a positioning system can be implemented to determine relative positioning of devices within the environment 101 and optionally to control or modify behavior of one or more devices based on the relative positions. Positioning or localization information can be acquired through various techniques, optionally using sensors in some instances, examples of which are discussed below. In certain examples, one or more devices in the MPS 100, such as one or more playback devices 110, NMDs 120, or controller devices 130 may host a localization application that may implement operations (also referred to herein as functional capabilities or functionalities) that process localization information to enhance user experiences with the MPS 100. Examples of such operations include sophisticated acoustic manipulation (e.g., functional capabilities directed to psychoacoustic effects during audio playback) and autonomous device configuration and/or reconfiguration (e.g., functional capabilities directed to detection and configuration of new devices or devices that have moved or otherwise been changed in some way), among others. The requirements that these operations place on localization information vary, with some operations requiring low latency, high precision localization information and other operations being able to operate using high latency, low precision localization information.

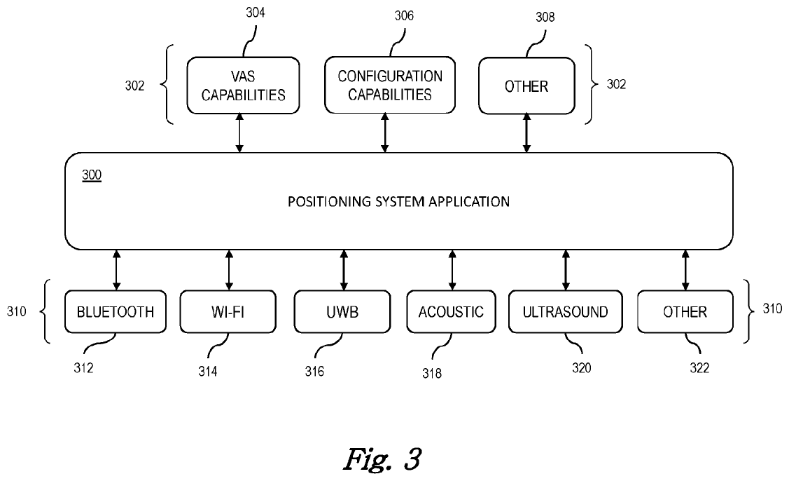

According to certain examples, a positioning system can be implemented in the MPS 100 using a variety of different devices to generate the localization information utilized by certain application functionalities. However, the number, arrangement, and configuration of these devices can vary between examples. Additionally, or alternatively, the communications technology and/or sensors employed by the devices can vary. Given the number of variables in play within any particular MPS and the concomitant inefficiencies that this variability imposes on MPS application operation development and maintenance, some examples disclosed herein utilize one or more playback devices 110, NMDs 120, or controller devices 130 to implement a positioning system using a common positioning application programming interface (API) that decouples the positioning/localization information from specific devices or underlying enabling technologies, as illustrated conceptually in FIG. 3.

Referring to FIG. 3, any one or more playback devices 110, NMDs 120, or controller devices 130 in the MPS 100 (“MPS devices”) can host a positioning system application 300. In certain implementations, one or more remote computing devices can facilitate hosting the application. The positioning system application 300 implements an application programming interface (API) that exposes positioning/localization information, and metadata pertinent thereto, to MPS application functionalities 302. The MPS functionalities 302 may include a wide variety of functional capabilities relating to various user experiences and aspects of the operation of the MPS 100. For example, the MPS functionalities 302 may include one or more VAS capabilities 304, such as voice disambiguation capabilities and arbitration between different NMDs receiving the same voice inputs, for example. The MPS functionalities 302 may also include one or more MPS and/or device configuration capabilities 306, such as automatic home theater configuration or reconfiguration, dynamically accommodating portable playback devices in home theater environments, dynamic room assignment for portable playback devices or their associated docks, and contextual orientation of controller devices 130, to name a few. The MPS functionalities 302 may further include one or more other functional capabilities 308 that use positioning/localization information. To support these and other MPS functionalities 302, positioning/localization information may be used to determine various pieces of information related to the locations of MPS devices within the environment 101. For example, the positioning/localization information may be used by some MPS functionalities 302 to keep track of which playback devices 110 or NMDs 120 are in a given room or space (e.g., which playback devices are in the Living Room 101f, in which room is playback device 110d, or which playback devices 110 are closest to the controller device 130). The positioning/localization information may further be used to determine the distance and/or orientation between playback devices 110 (with varying levels of precision), or to determine the acoustic space around NMDs 120 or NMD-equipped playback devices 110 (e.g., which playback devices 110 can be heard from NMD 120a). Thus, the positioning/localization information may be used to determine information about the topology of the MPS 100 within the environment 101, which information may then be used to automatically and dynamically create or modify user experiences with the MPS 100 and support the MPS functionalities 302.

In some examples, the positioning/localization information is obtained through the exchange of wireless signals among network devices (point-to-point signaling) within the MPS 100. For example, in response to a signaling trigger, some or all of the MPS devices emit one or more wireless signals and “listen” for the wireless signals emitted by other MPS devices. Each of the wireless signal can include a device identifier that identifies the network device from which the respective wireless signal was emitted. Based on detecting the various wireless signals, one or more of the MPS devices can determine certain positioning/localization information. For example, one or more MPS devices may establish a reference pattern that describes distances and directions between MPS devices based on signal strength measurements. In another example, an MPS device may detect the presence of another MPS device based on detecting the wireless signal(s) emitted by the other MPS device. In some examples, the signaling trigger is based on a schedule. For example, some or all of the MPS devices can be configured to periodically emit and/or listen for wireless signals. In another example, a coordinating MPS device may broadcast an instruction to other MPS devices directing the other MPS devices to emit and/or listen for wireless signals. In another example, a portable playback device that detects its movement (e.g., through an on-board sensor, such as a inertial measurement unit, or through connection to or disconnection from its docking station, or via some other mechanism) may broadcast a request for other MPS devices to emit the wireless signals, such that the portable playback device can determine its new position relative to one or more of the other MPS devices by detecting the wireless signals emitted by the one or more other MPS devices. Various other examples are possible.

The positioning/localization information and metadata exposed by the positioning system application 300 may vary depending on the underlying communications technologies and/or sensor capabilities 310 within the MPS devices that are used to acquire the information and/or the needs of the particular MPS functionality 302. For example, certain MPS devices may be equipped with one or more network interfaces 224 that support any one or more of the following communications capabilities: BLUETOOTH 312, WI-FI 314 or ultra-wide-band technology (UWB 316; a short-range radio frequency communications technology). Further, certain MPS devices may be equipped to support signaling via acoustic signaling 318, ultrasound 320, or other signaling and/or communications means 322. Certain technologies 310 may be well-suited to certain MPS functionalities 302 while others may be more useful in other circumstances. For example, UWB 316 may provide high precision distance measurements, whereas WI-FI 314 (e.g., using RSSI signal strength measurements) or ultrasound 320 may provide “room-level” topology information (e.g., presence detection indicating that a particular MPS device is within a particular room or space of the environment 101). In some examples, combinations of the different technologies 310 may be used to enhance the accuracy and/or certainty of the information derived from the positioning/localization information received from one or more MPS devices via the positioning system application 300. For example, as discussed further below, in some instances, presence detection may be performed primarily using ultrasound 320; however, RSSI measurements may be used to confirm the presence detection and/or provide more precise localization information in addition to the presence detection.

Examples of MPS devices equipped with ultrasonic presence detection are disclosed in U.S. Patent Publication Nos. 2022/0066008 and 2022/0261212, each of which is hereby incorporated herein by reference in its entirety for all purposes. Examples of localizing MPS devices based on RSSI measurements are disclosed in U.S. Patent Publication No. 2021/0099736, which is herein incorporated by reference in its entirety for all purposes. Examples of performing location estimation of MPS devices using WI-FI 314 are disclosed in U.S. Patent Publication No. 2021/0297168, which is herein incorporated by reference in its entirety for all purposes.

In addition to the positioning/localization information itself, some examples of the positioning system application 300 can expose metadata that specifies localization capabilities of the host MPS device, such as precision and latency information and availability of the various underlying capabilities 310. As such, the positioning system application 300 enables the MPS functionalities 302 each to utilize a common set of API calls to identify the localization capability present within their host MPS device and to access positioning/localization information made available through the identified capabilities 310.

As shown in FIG. 3 and discussed above, the positioning system application 300 can interoperate with MPS devices that support a wide variety of localization capabilities, such as BLUETOOTH 312, WI-FI 314, UWB 316, acoustic signaling 318 and/or ultrasound 320, among others 322. In some examples, the positioning system application 300 includes one or more adapters configured to communicate with MPS devices using syntax and semantics specific to the localization capability 310 of the MPS devices. This architecture shields the MPS functionalities 302 from the complexity of interoperating with each type of MPS device. In some examples, each adapter can receive and process a stream of positioning/localization data from the MPS devices using any one or more of the communications capabilities 310. The adapters can interoperate with an accumulation engine within the positioning system application 300 that analyzes and merges (e.g., using a set of configurable rules) positioning/localization data obtained by the adapters and populates data structures that contain the positioning/localization information and the metadata described above. These data structures, in turn, are accessed and the positioning/localization information, and metadata, are retrieved by the positioning system application 300 in response to API calls received by the positioning system application 300 to support the MPS functionalities 302. The positioning/localization information, and metadata, can specify, in some examples, position/location of a device relative to other device, absolute position/location (e.g., within a coordinate system) of a device, presence of device (e.g., within a structure, room, or as a simple Boolean value), and/or orientation of a device.

For instance, in some examples, the positioning/localization information is expressed in two dimensions (e.g., as coordinates in a Cartesian plane), in three dimensions (e.g., as coordinates in a Cartesian space), or as coordinates within other coordinate systems. In certain examples, the positioning/localization information is stored in one or more data structures that include one or more records of fields typed and allocated to store portions of the information. For instance, in at least one example, the records are configured to store timestamps in association with values indicative of location coordinates of a portable playback device taken at a time given by the associated timestamp. Further, in at least one example, the records are configured to store timestamps in association with values indicative of a velocity of a portable playback device taken at a time given by the associated timestamp. Further, in at least one example, the records are configured to store timestamps in association with values indicative of a segment of movement (starting and ending coordinates) of a portable playback device taken at times given by associated timestamps. Other examples of positioning/localization information, and structures configured to store the same, will be apparent in view of this disclosure.

It should be noted that the API and adapters implemented by the positioning system application 300 may adhere to a variety of architectural styles and interoperability standards. For instance, in one example, the API is a web services interface implemented using a representational state transfer (REST) architectural style. In this example, the API communications are encoded in Hypertext Transfer Protocol (HTTP) along with JavaScript Object Notation and/or extensible markup language. In some examples, portions of the HTTP communications are encrypted to increase security. Alternatively, or additionally, in some examples, the API is implemented as a.NET web API that responds to HTTP posts to particular URLs (API endpoints) with localization data or metadata. Alternatively, or additionally, in some examples, the API is implemented using simple file transfer protocol commands. Also, in some examples, the adapters are implemented using a proprietary application protocol accessible via a user datagram protocol socket. Thus, the adapters and the API as described herein are not limited to any particular implementation.

### IV. Techniques for Smart Sleep

Aspects and embodiments provide techniques for automated power management in a media playback system (such as the MPS 100 discussed above) based on learned patterns of device usage within a particular environment (such as the environment 101 discussed above). As previously explained, it is desirable to reduce the energy consumption of devices in a media playback system without negatively impacting the user's listening experience. To this end, aspects and embodiments provide power-saving techniques that include machine learning based approaches to develop personalized, user-centric power management schedules and/or settings based on learned routines and user preferences.

In a media playback system, such as the media playback system 100 discussed above, at certain times, one or more playback devices 110 may be playing back audio content (referred to herein as being “in use”), either alone or in synchrony with one or more other playback devices 110. However, one or more other playback devices 110 may be idle (e.g., not playing back audio content). As used herein, an “active” playback device is one that is not in the suspended state. An active playback device may be idle or in use. At times, all playback devices 110 in the media playback system 100 may be idle. As discussed above, idle playback devices 110 offer convenient opportunities to employ power-saving techniques without disrupting the user's listening experience. Accordingly, certain aspects and embodiments are directed to providing playback devices that are capable of entering a suspended state in which various electronic components are powered down (e.g., turned off or disabled), such that the power consumption of the playback device is significantly reduced while in the suspended state. In addition, according to certain examples, one or more playback devices can host a personalization service that employs one or more parameterized machine learning models to predict when playback devices can, or should, be put into a suspended state to reduce their power consumption. As described further below, the personalization service may implement a model predictive controller than can cause, based on predictions from the model) s), the idle playback devices, where appropriate, to enter the suspended state. The model(s) can operate based on gathered user- or household-specific, “local” data to develop predictions that are tailored to particular environments. In some examples, the model(s) can also incorporate non-user- or household-specific “global” trend data to provide an informed starting point for personalization while local data is being accumulated. Examples of personalized power-savings techniques, and playback devices configured to implement them, are described in more detail below.

In certain examples, when a playback device 110 enters the suspended state, one or more of its processors (e.g., processors 112a discussed above) and/or software components 112c are disabled to save power. Accordingly, the playback device 110 can be configured and/or programmed in a manner that enables this “turning off” of certain components and functionality, while retaining the ability to detect wake instructions and re-activate the disabled components to resume normal operations. In some examples, playback devices in the suspended state can use approximately 50% less power than when idle by disabling various processes and/or components, such as certain processing functionality performed by one or more processors 112a and radio processes.

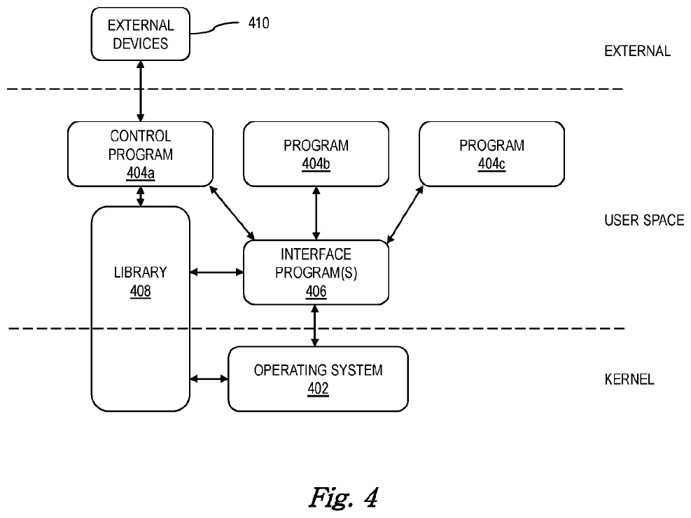

Referring to FIG. 4, in examples, a playback device 110 includes a plurality of software components, such as the software components 112c discussed above, that can be executed by one or more processors, such as the processor(s) 112a discussed above, to manage and implement various functionality of the playback device. For example, as shown in FIG. 4, the software components include an operating system 402, along with various user space programs 404a, 404b, 404c (collectively 404) and 406. By way of illustration, program 404a is a control program that configures the playback device 110 to play back audio via the one or more speakers (e.g., transduces 114) and the one or more amplifiers 112h. Accordingly, the control program 404a may be in communication with one or more external devices 410 (such as one or more other playback devices 110, control devices 130, or computing devices 106) to obtain audio content for playback, for example. Program 404b is a network and connection manager configured to manage wired and/or wireless connections via the network interface 112d. Program 404c is an upgrade manager configured to manage upgrades to the software components 112c of the portable playback device 110. These programs 404 are shown by way of example, and other implementations may include additional or fewer programs 404, as well as programs 404 that are responsible for different device functions.

In examples, the program 406 includes one or more power control programs that are configured to interface with and coordinate between the other user-space programs 404 and the operating system 402. The power control program(s) 406 may include a power management program that coordinates various aspects of configuring the playback device 110 into and out of the suspended state based on detecting corresponding sleep/suspend and wake/resume commands. In other examples, the programs 404 may communicate directly with the operating system 402 without interoperating with the power control program(s) 406 for coordination. The software components may further include a system library 408. The system library 408 provides the power control program(s) 406 with access to kernel functions, such as suspend (which configures the playback device into the suspended state), using commands, function calls, protocols, and/or objects, which are collectively referred to herein as instructions. To access such functions, the power control program(s) 406 may make a function call to the appropriate function in the system library 408. In examples, certain user-space programs 404 (e.g., the control program 404a) have access to the system library 408. Such access facilitates communication with kernel drivers, which control hardware components of the playback device 110. For example, the control program 404a may have access to the system library 408 to control kernel drivers corresponding to the audio pipeline (e.g., the audio processing components 112g and audio amplifier(s) 112h).

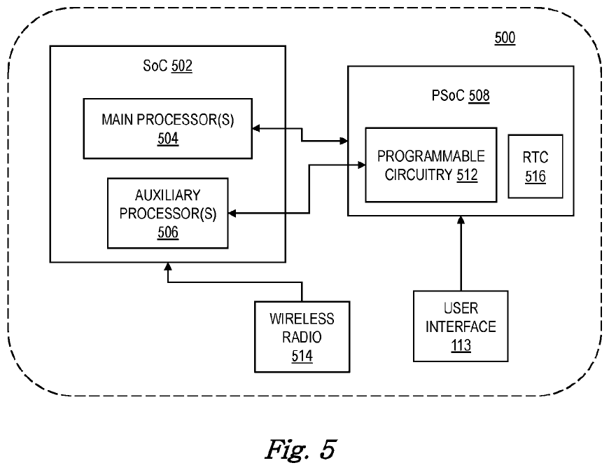

In some examples, the suspended state includes a “kernel suspend,” during which the main processor(s) of the playback device 110 are suspended and the kernel and user-space programs 404, 406 are not executing, which reduces power consumption of the playback device 110. However, since these programs are not executing, they cannot perform their intended functions. Accordingly, the playback device 110 can be configured and/or controlled to enter the suspended state only when doing so will not disrupt a user's listening experience. For example, when the playback device is idle, one or more user-space programs 404, such as the control program 404a, may not be executing, and therefore preventing these programs from executing by entering the suspended state may not have any adverse effect. In some examples, certain user-space programs 404 may be classified as programs that cannot be interrupted (such as the control program 404a, for example), and therefore, the playback device 110 may be prevented from entering the suspended state while one or more of these programs are executing. Other user-space programs 404 may be classified as interruptible, such that the playback device 110 can enter the suspended state even if one or more of these other programs 404 is executing. In addition, since the operating system 402 and the user-space programs 404, 406 are not executing when the playback device 110 is in the suspended state, a mechanism is provided, external to the kernel and user-space programs, to enable the playback device to detect instructions or other triggers that indicate that the playback device 110 is to exit the suspended state (“kernel resume”) and resume normal operations. FIG. 5 illustrates an architecture that facilitates kernel resume based on any of a plurality of kernel resume triggers from different components.

Referring to FIG. 5, there is illustrated a block diagram showing an example of electronic circuitry 500 that may be included in playback devices 110 that are equipped with the capability to enter the suspended state (also referred to as “sleep capability”). The circuitry 500 may include or may be part of the electronics 112 discussed above with reference to FIGS. 1C-1F. As shown in FIG. 5, the circuitry 500 includes a system-on-chip (SoC) 502, which in some examples is an implementation of the processor(s) 112a of the playback device 110. The SoC 502 includes one or more main processor(s) 504 and one or more auxiliary processor(s) 506. In one example, the main processor 504 and the auxiliary processor 506 are implemented as separate cores on the SoC 502. The operating system 402 executes on the SoC 502, and various user-space programs (e.g., 404, 406) execute on top of the kernel. The SoC 502 may communicate with external devices via a wireless radio 514.

In examples, when the playback device 110 is in the suspended state, the main processor 504 is disabled. Accordingly, the operating system 402 and/or any user-space programs 404, 406 executing on the main processors 504 are also disabled. In examples, during the suspended state, the main processor 504 is power gated to reduce power usage, but the auxiliary processor 506 is kept active to receive signals that trigger a kernel resume to cause the playback device 110 to exit the suspended state. Any of a variety of signals may trigger a kernel resume, as discussed further below. The main processor 504 is resumed by the auxiliary processor 506. For instance, detection of a particular signal by the auxiliary processor 506 may trigger execution of an interrupt service routine (ISR) that causes the main processor 504 to be resumed.

In the example illustrated in FIG. 5, the circuitry 500 includes a programmable system-on-chip (PSoC) 508, which is separately programmable from the SoC 502. However, in other examples, the PSoC 508 may be implemented as part of the SoC 502. The PSoC 508 includes various software and corresponding circuitry (identified collectively as programmable circuitry 512 in FIG. 5) configured to detect input data from various sources, such as the user interface 113. For example, as discussed above, the user interface 113 may include one or more capacitive touch portions that enable a user to provide instructions or commands to the playback device via a capacitive touch sensor. Thus, the programable circuitry 512 may include software and corresponding circuitry configured to receive input data from the capacitive touch portions of the user interface 113, interpret this data and generate corresponding commands, which are shared with the SoC 502 and ultimately the user-space programs 404 to control various functions. In some examples, the PSoC 508 includes a real-time clock (RTC) 516 that can be used to facilitate kernel resume events based on a schedule or other timing consideration, as discussed further below. The PSoC 508 may include other components as well.

The input data received by the PSOC 508 via the user interface 113 may include a kernel resume command (e.g., instructions or other input that indicates that the playback device 110 is to exit the suspended state). Accordingly, in some examples, when the playback device 110 is in the suspended state, the PSoC 508 remains active to generate kernel resume triggers (e.g., interrupts). For example, in some implementations, the programmable circuitry 512 generates a signal (e.g., an interrupt) when touch input is received via the user interface 113, which is sent to the auxiliary processor 506 to facilitate a wake-on-touch kernel resume event.

As another example, when a BLUETOOTH or WI-FI connection is made, the wireless radio 514 may generate a signal (e.g., an interrupt) that is sent to the auxiliary processor 506 to facilitate a wake-on-BLUETOOTH or wake-on-wireless kernel resume event. Various other kernel resume events can be processed by the circuitry 500 as well. For example, as discussed further below, data containing instructions from another playback device to cause the playback device to exit the suspended state may be received over a wireless (e.g., BLUETOOTH, WI-FI, or other) connection via the wireless radio 514, and an appropriate kernel resume trigger may be generated by the wireless radio 514.

When the playback device 110 is active, it may detect instructions to enter the suspended state. In some examples, these instructions may be in the form of one or more messages received from another playback device in the media playback system (e.g., via the wireless radio 514). In other examples, these instructions may be based on a schedule or detection of a suspend condition/trigger by the playback device 110 itself, any of which may generate internal messages that can be passed among the software components 112c of the playback device 110 to configure the playback device into the suspended state. For example, referring again to FIG. 4, the power control program(s) 406 may generate and/or receive such messages, and send instructions to the operating system 402 using the system library 408 (e.g., by using a function call or command) to cause the playback device 110 to enter the suspended state.

As noted above, in the suspended state, user-space programs, such as the control program 404a, are not executing and the main processor 504 is disabled. The playback device 110 may remain in the suspended state until a kernel resume trigger is detected. As discussed above, the kernel resume trigger may be based on a variety of inputs and/or conditions, such as a scheduled “wake” time, instructions received via one or more messages from another playback device, and/or user input, for example. In some examples, upon a kernel resume event, the system library 408 may record a source of the kernel resume trigger, which can be distributed to one or more of the user-space programs 404 by the interface program(s) 406.

This allows the user-space programs 404 to modify their operation based on the source of the kernel resume trigger. For instance, if the source of the kernel resume trigger is a wake-on-BLUETOOTH trigger, the control program 404a may change the playback source to streaming via BLUETOOTH. Other examples are possible as well.

As described above, according to certain embodiments, one or more playback devices 110 may be configured to automatically enter the suspended state and schedule a resume time based on learned device usage patterns. Accordingly, the MPS 100 can be configured to implement a personalization service that incorporates various machine learning approaches to personalize power management schedules for any one or more of the playback devices 110 in the MPS 100. The personalization service can be implemented by one or more of the playback devices 110 and/or control devices 130, individually or in combination. In some examples, personalization functionality can be accomplished using a model predictive controller that runs one or more parameterized machine learning models.

As discussed above, routines play a significant role in users' interactions with their media playback system, and these routines can shift over time. For example, users may have a different routine during the week versus over the weekend, during the summer versus during the winter, or during school vacation periods versus during school semesters. As discussed further below, aspects and examples disclosed herein incorporate contextual influence in the system's predictions, allowing the personalization service to adapt to changing behavior over both long and short timeframes. In particular, as discussed above, examples apply continual learning and confidence indicators to robustly determine usage patterns and apply sleep settings only in high confidence scenarios, thereby reducing the likelihood of negative user experiences caused by interactions with non-responsive (sleeping) playback devices.

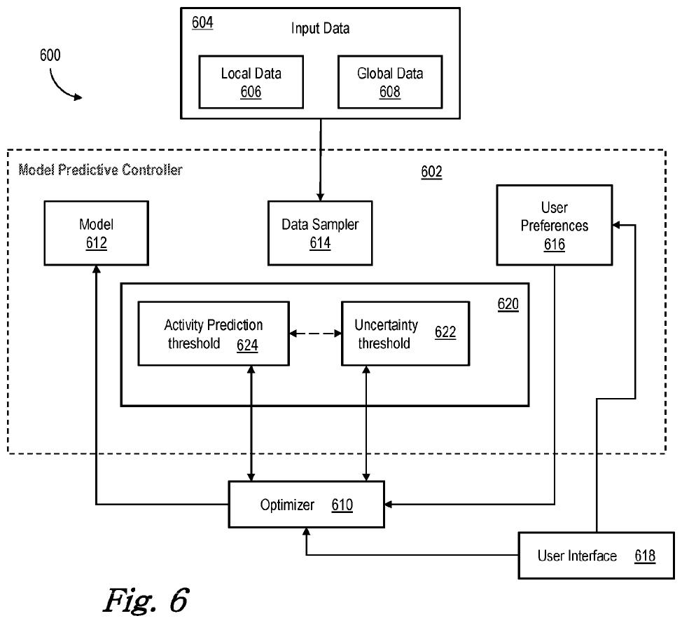

Referring to FIG. 6, there is illustrated a block diagram of one example of a machine learning system 600 that may be implemented within a media playback system, such as the media playback system 100 discussed above, and used to provide personalized power management functionality. The machine learning system 600 may be implemented, in whole or in part, on one or more network devices (e.g., playback devices 110, NMDs 120, or control devices 130) within the media playback system 100, or may be implemented, in whole or in part, on a cloud network device 102, for example. The machine learning system 600 may be implemented in software or using any combination of hardware and software capable of performing the functions disclosed herein.

In the example of FIG. 6, the machine learning system 600 includes a model predictive controller 602 that operates on input data 604, its operation being controlled by an optimizer 610. The model predictive controller (MPC) 602 includes a model 612, which may be a parameterized machine learning model, as discussed above. The MPC 602 further includes a data sampler 614, user preferences 616, and a confidence element 620. The confidence element 620 may apply two threshold values, namely an uncertainty threshold 622 and an activity prediction threshold 624, each of which is discussed further below. The confidence element 620 allows the system to accommodate uncertainty in the prediction (e.g., by using confidence indicators, as described below), which can lead to improved performance and minimize negative user experiences.

The input data 604 can comprise any data which is used to correlate playback device usage (activity status) with timing information, such as time of day, day of week, etc. The input data 604 can include “local” data 606 that is data collected from a specific environment 101. Collection of the local data 606 may occur at various intervals over time. For example, a data collection event may occur each time a user interacts with a network device in the media playback system 100 or may occur at other periodic or aperiodic times. The local data 606 collected at each data collection event is used by the machine learning system 600 to learn specific user routines and to apply power management settings when a learned routine has been established. In some examples, particularly to assist the system 600 when little or no local data 606 is available (e.g., when the system 600 is first activated or re-activated after a long period of inactivity, referred to herein as “cold start” situations), the input data 604 may include some “global” data 608 that is data collected from outside sources, such as a group of one or more other environments 101 or averaged trends from multiple environments 101, for example.

Certain examples include techniques for fusing local input data 606 and global input data 608 to assist in cold start situations and allow for optimization-driven data augmentation. In some such examples, the MPC 602 may operate as a “globally informed local model” in which in the input data 602 upon which the model 612 is run includes both local data 606 and global data 608. The data sampler 614 may determine how to combine the local and global data. In some examples, this operation of the data sampler 614 can be modified by a “proportion” hyperparameter that determines the mix, or by a more sophisticated sampling regime, for example. In some examples, the local data 606 is favored, and as more local data is accumulated over time, the global data can be phased out. Examples of using a combination of local data 606 and global data 608 are described further below.

In examples, the data sampler 614 intakes the input data 604 and extracts one or more input features to be used by the model 612. The model predictive controller 602 runs the model 612 based on parameters associated with the one or more features extracted from the input data 604 to produce a personalization result or recommendation. Examples of features may include the time of day, the day of the week, and the activity status (e.g., idle or in use) of one or more playback devices along with an identifier of each respective playback device (such that the activity status can be linked to corresponding playback device). In one example, a set of features that can be used to learn trends of playback device usage includes, for each monitored playback device: time since the start of the day (which allows the model to learn how usage of the playback device changes over the course of the day), time since the start of the week (which allows the model to learn how usage of the playback device changes over the course of the week), and activity status associated with each time period.

The model 612 uses the input data 604 to generate a set of parameters which yield a generalized function capable of predicting one or more particular output values (e.g., a predicted activity status of a particular playback device at a particular time of day) based on new input data 604. Parameters are variables that “belong” to the model 612 in that the trained model is represented by the model parameters. In contrast, hyperparameters are higher-level variables that affect the learning process and, thus, the values of the model parameters of the trained model 612. In some examples, training the model 612 involves choosing hyperparameters that the learning process uses to generate parameters that correctly map the input features (independent variables) to the labels (dependent variables) such that the model 612 produces predictions (e.g., predicted playback device activity states) with reasonable accuracy.

In the example illustrated in FIG. 6, the system 600 includes the optimizer 610 that operates based on one or more hyperparameters to optimize performance of the MPC 602. In some examples, the optimizer 610 selects hyperparameters for use during training of the model 612. Hyperparameters may include variables that determine characteristics such as an architecture of the model 612 (e.g., kernel selection or type of model (e.g., linear regression, Gaussian process, logistic regression, gradient boosted tree classifier, etc.), kernel size, etc.) how the model 612 is applied, the mix of local and/or global input data used, and/or variables that affect an optimization process used by the optimizer 610. A hyperparameter can, for example, take the form of a single continuous scalar variable or a discrete categorical variable (e.g., which kernel to use). Selection of hyperparameters has a significant impact on the performance (e.g., accuracy of predictions) of the trained model 612. Accordingly, in some examples, the optimizer 610 applies an optimization process to select the best hyperparameters for training the model 612. In some examples, this optimization process involves testing the performance of the system 600 on a validation dataset and adjusting the hyperparameters to produce an optimal result. Thus, the optimizer 610 may select certain hyperparameters, train a first model 612, and test the first model 612 using the validation data. The optimizer 610 may then tune the hyperparameters, train a second model 612, test the second model 612 using the validation data, and compare the performance to determine which hyperparameters produced a better result in the trained models. This process can be repeated to find optimal hyperparameters. In some examples, the optimizer 610 may use a grid search involving a field of combinations of hyperparameter values. In other examples, the optimizer 610 may apply a gradient descent optimization or a gradient-free optimization method, such as Bayesian optimization, or some combination thereof. As noted above, in some examples, the choice of optimization process can be a hyperparameter itself.

Thus, hyperparameters are “external” to the model 612 since they cannot be changed by the model during training, although they are tuned by the optimizer 610 to control the training of the model 612. As described above, a hyperparameter selected by the optimizer 610 can include a set of model parameters, as well as values that define the model architecture itself. In contrast, the model parameters are internal to the model 612 and their values are learned or estimated based on the input data 604 during training as the model 612 tries to learn the mapping between the input features and the labels. In some examples, training of the model 612 begins with the parameter values set to some initial default values (e.g., random values or set to zeros), and these initial values are updated as training/learning progresses under control of the optimizer 610, as described above.

According to certain examples, it is desirable to select a machine learning model that is capable of adapting to a variety of different contexts and to shifting routines over time, that can accommodate uncertainty (e.g., by using confidence indicators, as discussed above), and that is capable of learning based on relatively little data (e.g., hundreds to thousands of data points, rather than millions of data points). In one example, the model 612 is a Gaussian Process (GP) model. Gaussian Process models do not require large data sets, facilitate principled model uncertainty estimation, and can be tailored to specific tasks or patterns in the data through selection and/or configuration of the covariance function (kernel). Gaussian Process models can be used to interpret data with a strong periodic component (as many user behavioral patterns have) using a periodic kernel. Thus, a Gaussian Process model can be configured to encode periodic information related to user routines, which may be particularly relevant due to the strong periodicity present in many device usage patterns.

Examples of kernels that can be used for a Gaussian Process model 722 include a Gaussian kernel, a Matern kernel, and a periodic kernel. In addition to these kernels, white noise kernels are also used in some examples to account for variation in the input data.

The Gaussian kernel is described by the function:

$${σ}^{2} exp ( - \frac{{( x - {x}^{′} )}^{2}}{2 {l}^{2}} ) \qquad ( F1 )$$

In the function F1, l represents lengthscale, which is the learned parameter of the model. Using the Gaussian kernel, the similarity between data points increases with the square of their distance.

The Matern kernel is a generalization of the Gaussian kernel, allowing the smoothness of the corresponding function, F2, to be controlled via the parameter v. The additional flexibility allows the Matern kernel to adapt to “real world” data that may have significant variability. The Matern kernel is described by the function, F2:

$$\frac{1}{Γ ( v ) {2}^{v - 1}} {( \frac{\sqrt{2 v}}{l} d ( x , {x}^{′} ) )}^{v} {K}_{v} ( \frac{\sqrt{2 v}}{l} d ( x , {x}^{′} ) ) \qquad ( F2 )$$

In the function, F2, l represents lengthscale, which is the learned parameter of the model, and v is the smoothness parameter.

The periodic kernel is described by the function:

$${σ}^{2} exp ( \frac{- 2 {sin}_{2} ( π \vert x - {x}^{′} \vert / p )}{{l}^{2}} ) \qquad ( F3 )$$

In the function, F3, l represents lengthscale and p represents periodicity, which are both learned parameters of the model. Using the periodic kernel, data points are similar if they occur in similar regions of a periodic function. For example, 7 μm on Tuesday may be similar to 6:45 pm on Wednesday.

In some examples of the model 722, multiple kernels are combined in a Gaussian Process model to produce a more expressive covariance function.

Still referring to FIG. 6, as discussed above, in some examples, the MPC 602 incorporates uncertainty through the use of the confidence element 620. The uncertainty threshold 622 sets a threshold below which the prediction output by the model 612 is deemed sufficiently confident for use in developing and implementing an automated sleep schedule. The activity prediction threshold sets a threshold below which activity likelihood is deemed low enough for the playback device to enter the suspended state. In some instances, the uncertainty threshold 622 and/or the activity prediction threshold 624 can be hyperparameters that are applied (and optionally tuned) by the optimizer 610. For example, the uncertainty threshold 622 and/or the activity prediction threshold 624 may together define a trust region in which it is likely that acting on the model prediction will not result in undesirable system behavior (e.g., causing one or more playback devices to be in the suspended state during a time period in which a user is likely to want to interact with the playback devices) and a resulting negative user experience.

According to certain examples, the MPC 602 may further acquire and store user preference information, as indicated at 616. The user preferences 616 may include user-provided information regarding the level of personalization desired by the user and the importance of power savings to the user. For example, a user may indicate that they would like to achieve some power savings, but always want their playback devices to be available. In another example, a user may indicate that they want to achieve maximum power savings, even if that may mean that occasionally one or more playback devices are not immediately available (e.g., have to be manually brought out of the suspended state). In some examples, the user preferences 616 may be acquired via a user interface 618, which may be presented to the user via the user interface 133 on a control device 130, for example. For example, the user interface 616 may offer users a scale (e.g., 0 to 5) of choice regarding a desired level of personalization, with 0 being the lowest and 5 being the highest. Thus, for example, at level 0, the personalization service may be deactivated, thus presenting no risk of unwanted system behavior, but also offering no benefit to the user. Levels 1 through 4 may set constraints (such as values of the uncertainty threshold 622 and/or activity prediction threshold 622) within which the MPC 602 can operate. Level 5 may offer the greatest benefit, but also the greatest risk that the personalization may result in unwanted system behavior. Various other scales and user interface options can be implemented, as will be appreciated given the benefit of this disclosure.

Similarly, the user interface 616 may offer users a scale (e.g., 0 to 5) of choice regarding a desired level of energy saving, with 0 being the lowest and 5 being the highest. Thus, at level 0, the playback devices 110 may be set to never automatically enter the suspended state. Level 1 may offer minimal power saving opportunities, for example, only when it is extremely unlikely (e.g., approaching zero probability) that the user will encounter a sleeping playback device. In some examples, Level 1 may offer mean energy savings of 10%-20% relative to idle power consumption. Levels 2 through 4 may offer increased mean energy savings relative to Level 1 (e.g., in a range of 20%-30% relative to idle power consumption) but may also have increased risk that the user will encounter a sleeping playback device. Level 5 may offer maximum energy savings (e.g., 30%-50% relative to idle power consumption), but have an associated small risk (e.g., less than 5% of the time) that users will have to manually wake sleeping playback devices in order to use them. Various other scales and user interface options can be implemented, as will be appreciated given the benefit of this disclosure. The level of desired energy savings can be stored as part of the user preferences 616, along with the desired level of personalization, and used by the optimizer 610 and/or to set one or both of the activity prediction threshold 624 and the uncertainty threshold 622. In this manner, a user can be provided with a wide degree of control over the behavior of the system 600 such that the system 600 can be configured in accord with an individual user's own preferences and comfort level with system autonomy and personalization.

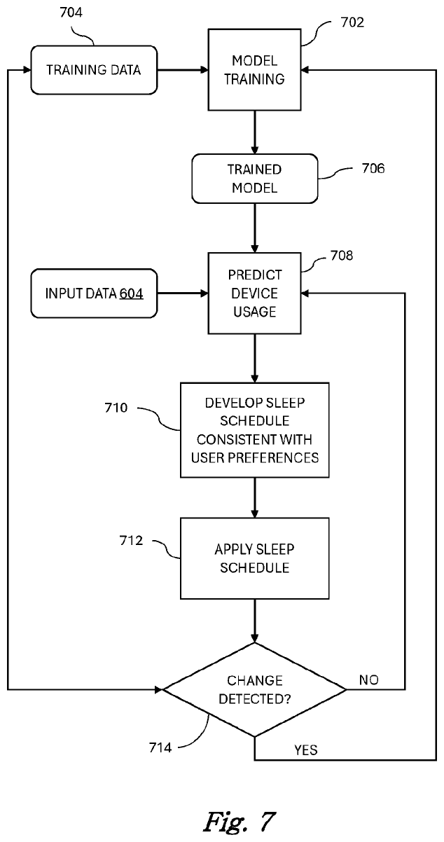

FIG. 7 illustrates a flow diagram corresponding to an example of implementing automated power savings using the machine learning system 600 in accord with certain embodiments. Examples of the process 700 of FIG. 7 are described below with continuing reference to FIG. 6.

According to certain examples, development of an automated sleep schedule can be framed as a combination of a regression problem with model predictive control implemented by the machine learning system 600. In particular, the MPC 602 can be configured to run the model 612 that is capable of playback device activity prediction based on historical input data 604. As described above, one such model 612 is a Gaussian Process model. Accordingly, the process 700 includes training the model 612 at operation 702 based on training data 704 to produce a trained model 612, as indicated at 706.

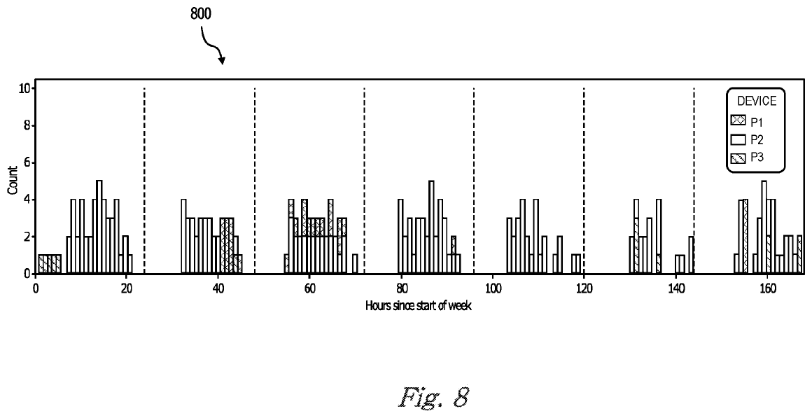

FIG. 8 illustrates an example of training data 800 that can be used during operation 702. FIG. 8 is a histogram depicting user requests to start playback by day of the week for three playback devices, P1, P2, and P3. As described above, the data sampler 614 processes the training data 704 to extract one or more features that will be used by the model 612. The same process may be applied by the data sampler 614 to the input data 604 to extract features that are used by the trained model 612 at operation 706 described below.

In one example, the data sampler 614 transforms the sample features derived from the training data 704 or input data 604 sample into a format appropriate for use by the model 612 depending on the configuration of the model parameters. For example, data samples in the training data 704 and/or input data 604 may be timestamped in the form of a Universal Standard Time (UTC) timestamp. The data sampler 614 may process the timestamped data sample to extract/derive the feature of the time since start of the week. In some examples, the data sampler 614 further processes the timestamp into floating point values to quantize the information into certain periods, such as hour-long intervals, for example.

During the training phase at operation 702, the machine learning system 600 may accumulate the training data 704 for a certain amount of time (e.g., a period of some number of weeks) before the model 612 is run in its predictive mode to generate playback device activity predictions at operation 706. In some examples, the number of weeks of data samples used to produce the histogram 800 is a hyperparameter of the optimizer 610. In some examples, in producing the training data 704, a smoothing process is applied to the histogram 800 to create margins around active times. For example, if the histogram 800 shows periods of activity at 11 am and 1 μm, but not at 12 μm, then 12 μm still has a non-zero potential activity level. Thus, smoothing can be applied to account for slight variation in user activity, helping to reduce the likelihood of a user encountering a sleeping playback device. In some examples, the length of the smoothing window used is another hyperparameter of the optimizer 610.

Once the model 612 is sufficiently trained, the trained model (at 706) can begin to produce “live” playback device activity predictions (at operation 708) that can be used by the MPC 602 to develop a sleep schedule at operation 710. In examples, the sleep schedule identifies a plurality of consecutive time intervals (e.g., hourly intervals) and, for each time interval, an associated activity status of one or more playback devices. The activity status specifies one of an active status or a sleep status in which the playback device suspends an operating system and one or more programs, the one or more programs including a control program configured to instruct the playback device to play back audio content, as described above. The activity status is based on the activity predictions output by the model 612 at operation 708.

According to certain examples, because the MPC 602 is configured to accommodate uncertainty in the model predictions, and user preferences 616, the activity status for each time interval is based on two values, namely the model prediction ŷ, and the model uncertainty estimate σ². These values can be combined by the MPC 602 as follows:

$${s}_{h} = ( \text{?} < {λ}_{α} ) \& ( {σ}_{h}^{2} < {λ}_{β} ) \qquad ( F4 )$$

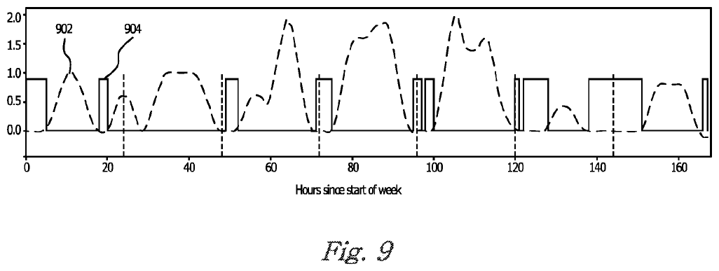

In function, F4, s is the sleep scheduler value (where 1 indicates the player is scheduled to sleep, 0 otherwise), λ_{α} is the activity prediction threshold 624, λ_{β} is the uncertainty threshold 622, and h is the hour. Applying the predictions from a Gaussian Process model 612 trained on the histogram 800 shown in FIG. 8 produces a model output and sleep schedule as shown in FIG. 9, based on λ_{α}=0.005, λ_{β}=0.2. In FIG. 9, trace 902 (dashed line) represents the model output, and trace 904 (solid line) represents the sleep schedule, with the “pulses” (e.g., durations for which trace 904 approaches 1.0) indicating times at which the player(s) are to be scheduled to sleep. In FIG. 9, the horizontal axis, and dashed vertical lines, represent the same time frame as depicted in FIG. 8.

At operation 712 the personalization service can automatically apply the generated sleep schedule to one or more playback devices 110 in the MPS 100 so as to cause those playback devices to enter and exit the suspended state according to the sleep schedule. In some examples, automatically implementing the sleep schedule for a playback device includes causing the playback device to (i) for each time interval having an associated sleep status, enter a suspended state in which the playback device suspends an operating system and one or more programs, the one or more programs including a control program configured to instruct the playback device to play back the audio content, and (ii) at a conclusion of each time interval having the associated sleep status, resume execution of the operating system and the one or more programs.

In certain examples, the model 612 can be configured to undergo continuous learning. Thus, in such examples, a given data sample may be both identified as training data 704 and also used as input data 604 by the model 612 in its predictive mode at operation 708. In some examples, the MPC 602 can be configured such that training occurs periodically to ensure that the model 612 is updated with respect to recent usage patterns. Further, as discussed above, personalized power management is based on learned device usage patterns over time; however, user routines can change over time, potentially causing the device usage patterns to change as well. Accordingly, in some examples, at operation 714, the process 700 includes, at operation 712, evaluating the training data set 704 to determine whether change criteria for the training data set 704 have been met. Change criteria may be met if any features added to the training data set 704 from the input data 604 are new or sufficiently different from existing features collected in the training data set 704 to warrant updating/re-training of the model 612. If the change criteria are met, then the process 700 returns to operation 702 to re-train the model 612. Otherwise, the process 700 continues at operation 708 to generate playback device activity predictions that are used by the MPC 602 to develop and/or update the sleep schedule at operation 710.

As described above, the MPC 602 is evaluated and tuned by the optimizer 610. In some examples, the validation data set corresponds to the training data set, optionally updated with additional input data 604 acquired over time. In some examples, the optimizer can be configured to attempt to tune the MPC 603 to minimize interruptions in the sleep schedule (interruptions being described by the probability of a user encountering a sleeping player) while maximizing the amount of time to have the playback device(s) in the suspended state, and thus maximize energy savings. This can be framed as a minimization problem by changing the second objective to minimizing the amount of time that the device(s) is/are awake. As also described above, the optimizer 610 can be constrained to address this minimization problem within constraints set or influenced by the user preferences 616. For example, the optimizer 610 can be constrained to optimize the model parameters within the “trust region” set by the uncertainty threshold 622 and the activity prediction threshold 624, as described above.

Table 1 below provides an example of a selection of hyperparameters that can be applied by the optimizer 610 for training the model 612.

TABLE 1

| Hyperparameter | Possible values | Description |
|---|---|---|
| Kernel | Matern 5/2, Matern | The kernel used with the |
| | 5/2 + periodic | Gaussian Process model 612 |
| Activity prediction | 0.0025, 0.005, 0.01, | The threshold below which |
| threshold 624 | 0.05, 0.1, | activity likelihood is deemed |
| | 0.2, 0.3, 0.4, 0.5 | low enough for the playback |
| | | device to sleep. |
| Uncertainty | 0.0025, 0.005, 0.01, | The threshold below which |
| threshold 622 | 0.05, 0.1, | the model output is deemed |
| | 0.2, 0.3, 0.4, 0.5 | sufficiently confident for use |
| | | in scheduling. |
| Number of zero | 20, 30 | The number of samples to |
| activity samples | | draw from inactive regions. |
| | | Increasing this may lead to |
| | | over-confidence when |
| | | predicting low-probability |
| | | activity regions, and so may |
| | | increase the likelihood of |
| | | interruptions. |
| Model | Per-player, | Whether the model is trained |
| configuration | per-household | as a general household-wide |
| | | model, or as a per-player |
| | | model in which the input data |
| | | encodes information about the |
| | | player model. |

According to certain examples, these hyperparameters can be tuned using validation data during the training phase at operation 702. In some examples, the hyperparameters are tuned using multi-objective optimization which attempts to balance maximizing power savings while minimizing interruptions, as described above. This is done by minimizing two objectives: the number of interruptions, and the negative percentage of power savings, according to Function (F5) below.

min_{θ∈Θ}(l−λkWh_{saved,θ}) (F5)

In Function (F5), l is the percentage of interruptions, θ is a set of parameters from all possible sets of parameters Θ, and λ is a weight applied to the power saving percentage to control the tradeoff between power saving and interruptions. In some examples where it is highly desirable to minimize interruptions, A can be set to 0.1.

The metric kWh_{saved} describes the percentage of power saved during playback device idle time when using the sleep schedule output by the MPC 602, and can be calculated with respect to baseline idle power consumption as follows:

The baseline power consumption for a week is calculated as:

kWh_{baseline}=h_{idle}×w_{player}/1000

Where h_{idle} is the number of idle hours in the week, and w_{player} is the idle power consumption for a player in Watts (which may be determined from playback device specifications, for example).

To compute the power consumption when using the sleep schedule output by the MPC 602, the idle time is broken down into two categories: hₛₗₑₑₚ is the idle time for which sleep has been scheduled, and h_{remaining} is the remaining idle time for which sleep has not been scheduled. The power consumption for sleep is computed via:

kWhₛₗₑₑₚ=hₛₗₑₑₚ×w_{player}/1000×0.47

The coefficient of 0.47 may be selected according to estimated power savings when a device is in the suspended state relative to being idle (e.g., ~50%, as discussed above). In other examples, a different coefficient value can be used. The remaining power consumption can then be computed as:

kWh_{remaining}=h_{remaining}×w_{player}/1000

Where the remaining idle time is any idle time for which sleep is not scheduled. The scheduler power consumption is therefore given by:

kWh_{scheduler}=kWhₛₗₑₑₚ+kWh_{remaining}

From the above, the percentage of power saved with respect to the baseline can be calculated as:

kWh_{saved}=kWh_{scheduler}/kWh_{baseline}×100

In some examples, since the optimizer 610 is configured to attempt to minimize interruptions, the personalization service may monitor when interruptions occur, and update training of the model 612 if the number and/or probability of interruptions is too high.

In some instances, during the training phase at operation 702, the model 612 may fail to learn to predict the activity schedule (within the constraints set by the optimizer 610) for one or more playback devices based on the training data set 704. In such instances, the MPC 602 may re-initialize the model 612, and the training process at operation 702 may be repeated using the training data 704. In some examples, if after re-training, the model 612 continues to fail to learn to predict an activity schedule for the playback device(s), the optimizer may alter one or more of the hyperparameters identified in Table. 1. For example, the optimizer may change the kernel of the model 612 (e.g., from a combined Matern and periodic kernel to a Matern kernel), and then re-train the model 612 using the training data set 704.

As noted in Table 1, another hyperparameter that may be used is the number of training data samples that are obtained from inactive time periods (e.g., time periods when the playback device(s) is/are not in use). As noted in table 1, increasing this number may lead to over-confidence when predicting low-probability activity time periods, and therefore may increase the likelihood of interruptions. Accordingly, if this number is too high, the model 612 may fail to learn to predict an activity schedule that meets the specified threshold limit for interruptions. Accordingly, based on continued failure of the model 612 to learn to predict an acceptable activity schedule, the number of training data samples in the training data 704 that are drawn from inactive time periods can be reduced to produce a reduced training data set, and model 612 can be re-trained using the reduced training data set.

As also noted above in Table 1, in some examples, another hyperparameter used by the optimizer 610 is whether the MPC 602 is configured to produce a power management schedule for individual playback devices 110 or for the MPS 100 as a whole. In the “per-household” model configuration (where the MPC 602 is configured to produce the power management schedule for the MPS 100 as a whole), the same sleep schedule is applied to all playback devices in the MPS 100. The per-household configuration may be simpler to develop and implement; however, to minimize the probability of interruptions, some playback devices that are idle while others are in use are not automatically placed into the suspended state (since the sleep schedule applies to all playback devices). Accordingly, some opportunities for power savings may be missed. In contrast, in the per-player configuration, the MPC 602 is configured to produce a dedicated sleep schedule for each individual playback device (or specified group of playback devices). In this case, the model 612 is trained with playback device-specific training data. In some examples, each playback device (or at least one playback device in a specified group of playback devices) may implement a version of the machine learning system 600. In another example, a single machine learning system 600 is used; however, the training data 704 is labeled with playback device identifying information. Accordingly, the model 612 can learn the correlations between the individual playback device identity and its associated activity/usage patterns, and thus generate (at operation 708) activity predictions for each playback device (or specified group of playback devices) individually.

Due to varying usage patterns from household to another, and differing numbers of playback devices in the associated MPSs 100, some households may benefit from the per-household configuration, whereas others may benefit from the per-player configuration. Accordingly, by allowing this configuration to be a hyperparameter that can be optimized by the optimizer 610, the better configuration can be selected for each household.

Thus, examples and embodiments provide techniques for smart sleep scheduling based on learned user routines and preferences. Through the use of personalization techniques described herein, the system capability can be enhanced and the user experience improved by enabling users to achieve desired outcomes with reduced manual effort and interaction. For example, playback devices can be automatically set to apply sleep schedules, thereby achieving power savings without requiring users to manually set up power management schedules.

### V. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular attribute, structure, or characteristic described in connection with the embodiment can be included in at least one example embodiment. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VI. Further Examples

The following examples pertain to further embodiments, from which numerous permutations and configurations will be apparent.

Example 1 provides a method of power management for a playback device, the method comprising acquiring a training data set containing correlations between playback device activity and time of day, training a parameterized machine learning model to predict an activity schedule for the playback device using the training data set, and collecting, over time, an operating data set including sample values of an activity status of the playback device and, for each respective sample value, a time at which the respective sample value was collected. The method further comprises applying the parameterized machine learning model to the operating data set to generate a predicted activity schedule for the playback device and a confidence metric corresponding to the predicted activity schedule, and based on the predicted activity schedule and the confidence metric, generating a power management schedule for the playback device, wherein the power management schedule identifies a plurality of consecutive time intervals and, for each time interval of the plurality of consecutive time intervals, an associated activity status of the playback device, the activity status corresponding to one of an active status or a sleep status in which the playback device suspends an operating system and one or more programs, the one or more programs including a control program configured to instruct the playback device to play back audio content.

Example 2 includes the method of Example 1, wherein generating the power management schedule further comprises dividing a first predetermined time period into a plurality of second predetermined time periods, associating each second predetermined time period with a respective activity status of the playback device based on the predicted activity schedule, and consolidating consecutive second predetermined time periods having a same activity status to produce the plurality of consecutive time intervals that, in combination, correspond to the first predetermined time period.

Example 3 includes the method of Example 2, wherein associating each second predetermined time period with a respective activity status of the playback device comprises determining that the respective activity status corresponds to the sleep status based on the predicted activity schedule indicating a predicted sleep status for that second predetermined time period and the confidence metric exceeding a predetermined threshold value, and otherwise determining that the respective activity status corresponds to the active status.

Example 4 includes the method of one of Examples 2 or 3, wherein the first predetermined time period is one day, and wherein each second predetermined time period is one hour.

Example 5 includes the method of any one of Examples 2-4, wherein consolidating the consecutive second predetermined time periods further comprises determining that a particular second predetermined time period having the sleep status falls between two adjacent second predetermined time periods having the active status, and changing the activity status of the particular second predetermined time period to the active status.

Example 6 includes the method of any one of Examples 1-5, further comprising automatically implementing the power management schedule for the playback device by causing the playback device to (i) for each time interval having an associated sleep status, enter a suspended state in which the playback device suspends an operating system and one or more programs, the one or more programs including a control program configured to instruct the playback device to play back the audio content, and (ii) at a conclusion of each time interval having the associated sleep status, resume execution of the operating system and the one or more programs.

Example 7 includes the method of Example 6, further comprising: while the playback device is in the suspended state, monitoring for a wake-up indicator, and based on detecting the wake-up indicator, (i) causing the playback device to resume execution of the operating system and the one or more programs, and (ii) storing an interruption sample including a time at which the wake-up indicator was detected.

Example 8 includes the method of Example 7, further comprising modifying the power management schedule based on the interruption sample.

Example 9 includes the method of one of Examples 7 or 8, further comprising retraining the parameterized machine learning model based the interruption sample and at least one of the training data set or the operating data set.

Example 10 includes the method of any one of Examples 1-9, further comprising acquiring user preference information associated with power management for the playback device, wherein generating the power management schedule includes generating the power management schedule based on the predicted activity schedule, the confidence metric, and the user preference information.

Example 11 includes the method of Example 10, wherein generating the power management schedule further comprises determining, for each consecutive time interval, the associated activity status of the playback device, by determining that the associated activity status corresponds to the sleep status based on the predicted activity schedule indicating a predicted sleep status and the confidence metric exceeding a predetermined threshold value, and otherwise determining that the respective activity status corresponds to the active status.

Example 12 includes the method of Example 11, wherein the predetermined threshold value is based on the user preference information.

Example 13 includes the method of any one of Examples 1-12, wherein acquiring the training data set comprises acquiring external training data from an external device.

Example 14 includes the method of Example 13, wherein acquiring the training data set further comprises collecting, over time, a test data set including test sample values of the activity status of the playback device and, for each respective test sample value, a time at which the respective test sample value was collected, such that the training data set comprises a combination of the external training data and the test data set.

Example 15 includes the method of Example 14, further comprising, after collecting the test data set for a predetermined period of time, updating the training data set to exclude the external training data, thereby producing an updated training data set, and retraining the parameterized machine learning model using the updated training data set.

Example 16 includes the method of any one of Examples 1-15, wherein the parameterized machine learning model is a Gaussian Process model.

Example 17 includes the method of Example 16, further comprising, based on a failure of the parameterized machine learning model to learn to predict the activity schedule for the playback device based on the training data set, (i) re-initializing the parameterized machine learning model, and (ii) retraining the parameterized machine learning model using the training data set.

Example 18 includes the method of Example 17, further comprising, after re-initializing the parameterized machine learning model, based on a continued failure of the parameterized machine learning model to learn to predict the activity schedule, (i) changing a kernel of the parameterized machine learning model, and (ii) retraining the parameterized machine learning model using the training data set.

Example 19 includes the method of Example 18, wherein changing the kernel of the parameterized machine learning model includes changing the kernel from a combined Matern and periodic kernel to a Matern kernel.

Example 20 includes the method of one of Examples 18 or 19, further comprising, after changing the kernel of the parameterized machine learning model, based on the continued failure of the parameterized machine learning model to learn to predict the activity schedule, (i) reducing a number of training data samples in the training data set to produce a reduced training data set, and (ii) retraining the parameterized machine learning model using the reduced training data set.

Example 21 includes the method of any one of Examples 1-20, wherein applying the parameterized machine learning model to the operating data set to generate the predicted activity schedule comprises generating the predicted activity schedule for a first time period corresponding to a totality of the plurality of consecutive time intervals, wherein the predicted activity schedule identifies a plurality of second time periods, each second time period having an associated predicted activity status, a sum of the plurality of second time periods corresponding to the first time period, and wherein, for each second time period, the associated predicted activity status is one of the active status or the sleep status.

Example 22 includes the method of Example 21, wherein generating the predicted activity schedule comprises for each respective second time period, (i) setting the associated predicted activity status to the sleep status based on a probability of the playback device being active during the respective second time period being below an activity prediction threshold, or (ii) otherwise setting the predicted activity status to the active status.

Example 23 includes the method of one of Examples 21 or 22, wherein generating the power management schedule for the playback device, comprises for each time interval of the plurality of consecutive time intervals, (i) identifying the associated activity status of the playback device as the sleep status based on a corresponding respective second time period in the predicted activity schedule having the sleep status and the confidence metric exceeding a confidence threshold value, or (ii) otherwise identifying the associated activity status of the playback device as the active status.

Example 24 includes the method of one of Examples 22 or 23, further comprising tuning the parameterized machine learning model using one or more hyperparameters.

Example 25 includes the method of Example 24, wherein the one or more hyperparameters include any one or more of a kernel of the parameterized machine learning model, the activity prediction threshold, or the confidence threshold value.

Example 26 provides a playback device comprising one or more speakers, one or more amplifiers configured to drive the one or more speakers, one or more processors, and at least one non-transient machine-readable medium storing program instructions that, when executed by the one or more processors configure the playback device to implement the method of any one of Examples 1-25.

Example 27 provides a power management method for playback devices in a media playback system, the method comprising acquiring a training data set containing correlations between playback device activity and time of day, training a parameterized machine learning model to predict an activity schedule for one or more playback devices in the media playback system using the training data set, and collecting, over time, an operating data set including sample values of an activity status of the one or more playback devices and, for each respective sample value, a time at which the respective sample value was collected and an identifier of associated playback device of the one or more playback devices. The method further comprises applying the parameterized machine learning model to the operating data set to generate a predicted activity schedule for the one or more playback devices and a confidence metric corresponding to the predicted activity schedule, and based on the predicted activity schedule and the confidence metric, generating a power management schedule for at least one playback device of the one or more playback devices, wherein the power management schedule identifies a plurality of consecutive time intervals and, for each time interval of the plurality of consecutive time intervals, an associated activity status of the at least one playback device, the activity status corresponding to one of a sleep status in which the at least one playback device suspends an operating system and one or more programs, the one or more programs including a control program configured to instruct the at least one playback device to play back audio content, or an active status.

Example 28 includes the method of Example 27, wherein generating the power management schedule comprises generating a first power management schedule for a first playback device in the media playback system, and generating a second power management schedule for a second playback device in the media playback system.

Example 29 includes the method of one of Examples 27 or 28, further comprising determining that a particular time interval having the sleep status falls between two adjacent time intervals having the active status, and changing the activity status of the particular time interval to the active status.

Example 30 includes the method of one of Examples 27 or 29, further comprising automatically implementing the power management schedule for the at least one playback device by causing the at least one playback device to (i) for each time interval having an associated sleep status, enter a suspended state in which the at least one playback device suspends an operating system and one or more programs, the one or more programs including a control program configured to instruct the at least one playback device to play back the audio content, and (ii) at a conclusion of each time interval having the associated sleep status, resume execution of the operating system and the one or more programs.

Example 31 includes the method of Example 30, wherein automatically implementing the power management schedule for the at least one playback device includes automatically implementing the power management schedule for the one or more playback devices as a group.

Example 32 includes the method of any one of Examples 27-31, further comprising acquiring user preference information associated with power management for the media playback system, wherein generating the power management schedule includes generating the power management schedule based on the predicted activity schedule, the confidence metric, and the user preference information.

Example 33 includes the method of Example 32, wherein generating the power management schedule further comprises determining, for each consecutive time interval, the associated activity status of the at least one playback device, by determining that the associated activity status corresponds to the sleep status based on the predicted activity schedule indicating a predicted sleep status and the confidence metric exceeding a predetermined confidence threshold value, and otherwise determining that the respective activity status corresponds to the active status.

Example 34 includes the method of Example 33, wherein the predetermined confidence threshold value is based on the user preference information.

Example 35 includes the method of one of Examples 33 or 34, wherein applying the parameterized machine learning model to the operating data set to generate a predicted activity schedule for the one or more playback devices comprises generating the predicted activity schedule including a plurality of time periods, each time period having an associated predicted activity status for each of the one or more playback devices.

Example 36 includes the method of Example 35, wherein generating the predicted activity schedule comprises for each respective time period, (i) setting the associated predicted activity status for a respective playback device of the one or more playback devices to the sleep status based on a probability of the respective playback device being active during the respective time period being below an activity prediction threshold, or (ii) otherwise setting the associated predicted activity status for the respective playback device to the active status.

Example 37 includes the method of Example 36, further comprising tuning the parameterized machine learning model using one or more hyperparameters.

Example 38 includes the method of Example 37, wherein the one or more hyperparameters include any one or more of a kernel of the parameterized machine learning model, the activity prediction threshold, the predetermined confidence threshold value, or a configuration of the parameterized machine learning model, and wherein the configuration of the parameterized machine learning model is one of a group configuration in which the parameterized machine learning model generates the predicted activity schedule for the one or more playback devices as a group, or a device configuration in which the parameterized machine learning model generates the predicted activity schedule for the at least one playback device individually.

Example 39 includes the method of Example 38, wherein the kernel of the parameterized machine learning model is one of a combined Matern kernel and periodic kernel or a Matern kernel.

Example 40 includes the method of any one of Examples 27-39, wherein acquiring the training data set comprises acquiring external training data from an external device.

Example 41 includes the method of Example 40, wherein acquiring the training data set further comprises collecting, over time, a test data set including test sample values of the activity status of the one or more playback devices and, for each respective test sample value, a time at which the respective test sample value was collected and an identifier of an associated playback device of the one or more playback devices, such that the training data set comprises a combination of the external training data and the test data set.

Example 42 includes the method of any one of Examples 27-41, further comprising, after collecting the test data set for a predetermined period of time, updating the training data set to exclude the external training data, thereby producing an updated training data set, and retraining the parameterized machine learning model using the updated training data set.

Example 43 provides a playback device comprising one or more speakers, one or more amplifiers configured to drive the one or more speakers, one or more processors, and at least one non-transient machine-readable medium storing program instructions that, when executed by the one or more processors configure the playback device to implement the method of any one of Examples 27-42.

Example 44 provides a playback device comprising a user interface, a wireless communication interface, one or more processors, and at least one non-transient computer-readable medium storing program instructions that, when executed by the one or more processors, cause the playback device to: acquire, via the wireless communication interface, a training data set containing correlations between playback device activity and time of day, train a parameterized machine learning model to predict an activity schedule for the playback device using the training data set, collect, over time, an operating data set including sample values of an activity status of the playback device and, for each respective sample value, a time at which the respective sample value was collected, apply the parameterized machine learning model to the operating data set to generate a predicted activity schedule for the playback device and a confidence metric corresponding to the predicted activity schedule, and based on the predicted activity schedule and the confidence metric, generate a power management schedule for the playback device, wherein the power management schedule identifies a plurality of consecutive time intervals and, for each time interval of the plurality of consecutive time intervals, an associated activity status of the playback device, the activity status corresponding to one of a sleep status in which the playback device suspends an operating system and one or more programs, the one or more programs including a control program configured to instruct the playback device to play back audio content, or an active status.

Example 45 includes the playback device of Example 43, wherein to generate the power management schedule, the at least one non-transient computer-readable medium further stores program instructions that, when executed by the one or more processors, cause the playback device to: for each respective first time period of a plurality of first time periods, associate the respective first time period with a corresponding activity status of the playback device based on the predicted activity schedule, and consolidate consecutive first time periods having a same activity status to produce the plurality of consecutive time intervals that, in combination, correspond to a second predetermined time period.

Example 46 includes the playback device of Example 45, wherein each respective first time period is one hour, and wherein the second predetermined time period is one day.

Example 47 includes the playback device of one of Examples 44 or 45, wherein to associate each respective first time period with the corresponding activity status of the playback device, the at least one non-transient computer-readable medium further stores program instructions that, when executed by the one or more processors, cause the playback device to: for a particular first time period, determine that the corresponding activity status corresponds to the sleep status based on the predicted activity schedule indicating a predicted sleep status for the particular first time period and the confidence metric exceeding a predetermined threshold value, and otherwise determine, for the particular first time period, that the corresponding activity status corresponds to the active status.

Example 48 includes the playback device of any one of Examples 45-47, wherein to consolidate the consecutive first time periods, the at least one non-transient computer-readable medium further stores program instructions that, when executed by the one or more processors, cause the playback device to: determine that a particular first time period having the sleep status falls between two adjacent first time periods having the active status, and change the activity status of the particular first time period to the active status.

Example 49 includes the playback device of any one of Examples 44-48, wherein the at least one non-transient computer-readable medium further stores program instructions that, when executed by the one or more processors, cause the playback device to automatically implement the power management schedule for the playback device by causing the playback device to (i) for each time interval having an associated sleep status, enter a suspended state in which the playback device suspends an operating system and one or more programs, the one or more programs including a control program configured to instruct the playback device to play back the audio content, and (ii) at a conclusion of each time interval having the associated sleep status, resume execution of the operating system and the one or more programs.

Example 50 includes the playback device of Example 49, wherein at least one non-transient computer-readable medium further stores program instructions that, when executed by the one or more processors, cause the playback device to: while the playback device is in the suspended state, monitor for a wake-up indicator, and based on detecting the wake-up indicator via one of the wireless communication interface or the user interface, (i) cause the playback device to resume execution of the operating system and the one or more programs, and (ii) store an interruption sample including a time at which the wake-up indicator was detected.

Example 51 includes the playback device of Example 50, wherein the at least one non-transient computer-readable medium further stores program instructions that, when executed by the one or more processors, cause the playback device to modify the power management schedule based on the interruption sample.

Example 52 includes the playback device of one of Examples 50 or 51, wherein the at least one non-transient computer-readable medium further stores program instructions that, when executed by the one or more processors, cause the playback device to retrain the parameterized machine learning model based the interruption sample and at least one of the training data set or the operating data set.

Example 53 includes the playback device of any one of Examples 44-52, wherein the at least one non-transient computer-readable medium further stores program instructions that, when executed by the one or more processors, cause the playback device to: acquire user preference information associated with power management for the playback device, and generate the power management schedule based on the predicted activity schedule, the confidence metric, and the user preference information.

Example 54 includes the playback device of any one of Examples 44-53, wherein the at least one non-transient computer-readable medium further stores program instructions that, when executed by the one or more processors, cause the playback device to, after collecting the operating data set for a predetermined period of time, retrain the parameterized machine learning model using the operating data set.

Example 55 includes the playback device of any one of Examples 44-54, wherein the parameterized machine learning model is a Gaussian Process model.

1. A method of power management for a playback device, the method comprising:
acquiring a training data set containing correlations between playback device activity and time of day;
training a parameterized machine learning model to predict an activity schedule for the playback device using the training data set;
collecting, over time, an operating data set including sample values of an activity status of the playback device and, for each respective sample value, a time at which the respective sample value was collected;
applying the parameterized machine learning model to the operating data set to generate a predicted activity schedule for the playback device and a confidence metric corresponding to the predicted activity schedule; and
based on the predicted activity schedule and the confidence metric, generating a power management schedule for the playback device, wherein the power management schedule identifies a plurality of consecutive time intervals and, for each time interval of the plurality of consecutive time intervals, an associated activity status of the playback device, the activity status corresponding to one of an active status or a sleep status in which the playback device suspends an operating system and one or more programs, the one or more programs including a control program configured to instruct the playback device to play back audio content.

2. The method of claim 1, wherein generating the power management schedule further comprises:
dividing a first predetermined time period into a plurality of second predetermined time periods;
associating each second predetermined time period with a respective activity status of the playback device based on the predicted activity schedule; and
consolidating consecutive second predetermined time periods having a same activity status to produce the plurality of consecutive time intervals that, in combination, correspond to the first predetermined time period.

3. The method of claim 2, wherein associating each second predetermined time period with a respective activity status of the playback device comprises:
determining that the respective activity status corresponds to the sleep status based on the predicted activity schedule indicating a predicted sleep status for that second predetermined time period and the confidence metric exceeding a predetermined threshold value; and
otherwise determining that the respective activity status corresponds to the active status.

4. (canceled)

5. The method of claim 2, wherein consolidating the consecutive second predetermined time periods further comprises:
determining that a particular second predetermined time period having the sleep status falls between two adjacent second predetermined time periods having the active status; and
changing the activity status of the particular second predetermined time period to the active status.

6. The method of claim 1, further comprising:
automatically implementing the power management schedule for the playback device by causing the playback device to (i) for each time interval having an associated sleep status, enter a suspended state in which the playback device suspends an operating system and one or more programs, the one or more programs including a control program configured to instruct the playback device to play back the audio content, and (ii) at a conclusion of each time interval having the associated sleep status, resume execution of the operating system and the one or more programs.

7. The method of claim 6, further comprising:
while the playback device is in the suspended state, monitoring for a wake-up indicator; and
based on detecting the wake-up indicator, (i) causing the playback device to resume execution of the operating system and the one or more programs, and (ii) storing an interruption sample including a time at which the wake-up indicator was detected.

8. (canceled)

9. The method of claim 7, further comprising:
retraining the parameterized machine learning model based the interruption sample and at least one of the training data set or the operating data set.

10. The method of claim 1, further comprising:
acquiring user preference information associated with power management for the playback device;
wherein generating the power management schedule includes generating the power management schedule based on the predicted activity schedule, the confidence metric, and the user preference information.

11. The method of claim 10, wherein generating the power management schedule further comprises determining, for each consecutive time interval, the associated activity status of the playback device, by:
determining that the associated activity status corresponds to the sleep status based on the predicted activity schedule indicating a predicted sleep status and the confidence metric exceeding a predetermined threshold value; and
otherwise determining that the respective activity status corresponds to the active status.

12. (canceled)

13. The method of claim 1, wherein acquiring the training data set comprises:
acquiring external training data from an external device.

14. The method of claim 13, wherein acquiring the training data set further comprises:
collecting, over time, a test data set including test sample values of the activity status of the playback device and, for each respective test sample value, a time at which the respective test sample value was collected, such that the training data set comprises a combination of the external training data and the test data set.

15. The method of claim 14, further comprising:
after collecting the test data set for a predetermined period of time, updating the training data set to exclude the external training data, thereby producing an updated training data set; and
retraining the parameterized machine learning model using the updated training data set.

16. (canceled)

17. The method of claim 1, wherein the parameterized machine learning model is a Gaussian Process model, the method further comprising:
based on a failure of the parameterized machine learning model to learn to predict the activity schedule for the playback device based on the training data set, (i) re-initializing the parameterized machine learning model, and (ii) retraining the parameterized machine learning model using the training data set.

18. The method of claim 17, further comprising:
after re-initializing the parameterized machine learning model, based on a continued failure of the parameterized machine learning model to learn to predict the activity schedule, (i) changing a kernel of the parameterized machine learning model, and (ii) retraining the parameterized machine learning model using the training data set.

19. The method of claim 18, wherein changing the kernel of the parameterized machine learning model includes changing the kernel from a combined Matern and periodic kernel to a Matern kernel.

20. The method of claim 19, further comprising:
after changing the kernel of the parameterized machine learning model, based on the continued failure of the parameterized machine learning model to learn to predict the activity schedule, (i) reducing a number of training data samples in the training data set to produce a reduced training data set, and (ii) retraining the parameterized machine learning model using the reduced training data set.

21. The method of claim 1, wherein applying the parameterized machine learning model to the operating data set to generate the predicted activity schedule comprises:
generating the predicted activity schedule for a first time period corresponding to a totality of the plurality of consecutive time intervals;
wherein the predicted activity schedule identifies a plurality of second time periods, each second time period having an associated predicted activity status, a sum of the plurality of second time periods corresponding to the first time period; and
wherein, for each second time period, the associated predicted activity status is one of the active status or the sleep status.

22. The method of claim 21, wherein generating the predicted activity schedule comprises:
for each respective second time period, (i) setting the associated predicted activity status to the sleep status based on a probability of the playback device being active during the respective second time period being below an activity prediction threshold, or (ii) otherwise setting the predicted activity status to the active status.

23. The method of claim 21, wherein generating the power management schedule for the playback device, comprises:
for each time interval of the plurality of consecutive time intervals, (i) identifying the associated activity status of the playback device as the sleep status based on a corresponding respective second time period in the predicted activity schedule having the sleep status and the confidence metric exceeding a confidence threshold value, or (ii) otherwise identifying the associated activity status of the playback device as the active status.

24. The method of claim 22, further comprising:
tuning the parameterized machine learning model using one or more hyperparameters;
wherein the one or more hyperparameters include any one or more of a kernel of the parameterized machine learning model, the activity prediction threshold, or the confidence threshold value.

25-54. (canceled)
